(19) United States
(12) Patent Application Publication
(10) Pub. No.: US 2019/0091710 A1
(43) Pub. Date: Mar. 28, 2019

(54) DISPENSER PUMPS

(71) Applicant: RIEKE PACKAGING SYSTEMS LIMITED, Leicestershire (GB)

(72) Inventor: Simon Christopher KNIGHT, Glamorgan (GB)

(21) Appl. No.: 16/082,952

(22) PCT Filed: Mar. 7, 2017
(86) PCT No.: PCT/EP2017/055375

§ 371 Date: Sep. 7, 2018

(30) Foreign Application Priority Data
Mar. 7, 2016 (GB) 1603857.2

(51) Int. Cl. B05B 11/00

(52) U.S. Cl. CPC B05B 11/3025; B05B 11/3074; B05B 11/007; B05B 11/3052; B05B 11/3047; B05B 11/3076

(57) ABSTRACT

A dispenser pump for spraying a fine mist has a plunger (2) reciprocable in a pump body (3). The plunger has a head (4) and a stem (5). A closure (8) holds the pump in a container neck, and has an external decorative crimp sleeve (82). The plunger head has a matching external trim (72). A pump spring (7) is mounted outside the pump chamber (71), around the stem above the piston thereof. A pre-compression spring (75) acts to delay opening of the outlet piston seal until sufficient pressure builds in the pump chamber (71).

This invention has to do with pumps and pump dispensers, with particular reference to spray dispensers with pre-compression although concepts disclosed here are more broadly applicable.

### BACKGROUND

Spray dispensers for dispensing a fine mist are widely used for perfumery, cosmetics, and toiletries in general. Usually they feature a depressible plunger whose head includes an atomiser nozzle to form a spray. Often the pump incorporates a pre-compression feature so that spraying starts only when adequate positive pressure has built up on the downstroke of the plunger. The pump mechanism is typically a piston-and-cylinder pump, with the piston carried by the plunger and having a pump spring or return spring which biases the plunger to the “up” (extended) position. The pump spring is conveniently positioned between a downward shoulder on the plunger stem and the bottom of the pump body cylinder near the inlet. The piston is usually carried by a sliding seal member, movable on the plunger stem between lower and upper stops to cover or uncover one or more entry openings leading from the pump chamber into the outlet passage in the plunger stem; this constitutes an outlet valve. Pre-compression can be by spring-biasing the piston/seal member down towards the lower stop so that it continues to block the outlet passage entrance after plunger depression begins, until pump chamber pressure builds sufficiently to push the sliding seal back against the pre-compression spring.

These dispensers are often used for toiletries, scent sprays and the like so an attractive appearance may be important. The plunger head may be available with a variety of different appearances (e.g. colour finishes, textures, trim components, shape styles), to be selected and fixed onto the top of an otherwise standard (appearance non-specific) pump module or pump precursor. A closure of the pump, which holds and orients the pump body relative to a container neck, may also exist with a range of different appearances and these may be selectable to match the plunger head. This selection or matching often occurs separately from the initial assembly of the pump modules, perhaps at a separate facility closer to retail shipping. For assembly the plunger heads are made to be simply pushed onto the tops of the plunger stems.

Separately, there is an increasing demand in the dispenser field for “no metal contact” products in which the liquid to be dispensed does not pass over or reside in contact with metal pump elements, and in particular not the metal pump spring. Some dispensers lend themselves to designs in which the pump spring can readily be positioned out of the liquid flow path (see e.g. GB2491576A, GB2491104A and EP0691161A) but this is not always straightforward. In a spray dispenser of the kind described, re-positioning the spring around the plunger stem above the piston seal is problematic. A pre-compression spring takes up axial space at the bottom of the stem. It is undesirable to expose the spring at the top of the pump. Also, a spring acting against the plunger head at the top is not practical if the plunger head is to be fitted only later.

### THE INVENTION

In these proposals, we address the above issues and provide new proposals for dispenser pumps, especially spray pumps, especially spray pumps and spray dispensers.

In a first aspect the present invention relates to a dispenser pump comprising a body and a plunger;

the body defining a pump chamber having an inlet with an inlet valve, the pump chamber communicating with an outlet passage and the plunger being reciprocable relative to the body between an extended position and a depressed position in a dispensing stroke to drive liquid from the pump chamber through the outlet passage to a discharge nozzle thereof;

the plunger comprising an actuating head and a stem portion, a return spring acting between the body and the plunger to urge the plunger towards the extended position, the return spring being compressed as the plunger is moved to the depressed position;

wherein the return spring is a coil spring disposed around the plunger stem outside the pump chamber, the body comprising a pump spring abutment and an inner end of the spring engaging the pump spring abutment.

Preferably the pump dispenser is a spray dispenser, the discharge nozzle being an atomiser nozzle.

Preferably the plunger comprises a dependent spring surround, and the body comprises an upstanding spring surround, the depending and upstanding spring surrounds moving telescopically together and surrounding the pump spring.

Generally the plunger comprises a top spring abutment to engage the top of the pump spring and the body comprises a bottom spring abutment to engage the bottom of the pump spring.

The plunger may comprise an adapter piece or spring retainer providing or comprising the top spring abutment. The spring-retaining adapter is fastened to the top of the plunger stem; desirably it is a discrete component i.e. discrete from the stem. It may plug into and/or onto or around the top of the stem tube. Preferably it engages the stem to resist axial removal, e.g. by a snap fit. It may be generally tubular. It may plug into the top of the stem, e.g. comprising an inner fixing tube portion which plugs into the top of the plunger stem. Or, it may be a ring which fits on around the top of the plunger stem.

The top spring abutment may be provided by an outward projection, especially a radially-outward projection, such as a flange and most preferably a circular radial flange or plate of the spring-retaining adapter. Or, it may be a lower surface of an annular spring retainer. This projection may be at or adjacent the top of the plunger stem. The top of the pump spring may engage its underside directly.

The spring-retaining adapter may comprise an outer surround portion which surrounds the pump spring. This may be in the form of a dependent skirt or tube, e.g. depending from an outer edge of a structure such as a radial projection which forms the top spring abutment. The dependent spring surround may be generally cylindrical. It has an open bottom end.

The head and stem of the plunger are typically discrete components which connect together at respective joint formations thereof. Typically the head has a socket and the top of the plunger stem has a plug formation to fit it. Preferably the spring-retaining adapter constitutes or is comprised in the plug formation at the top of the plunger stem, so that e.g. it plugs into a socket formation of the plunger head.

The plunger head may define a second part of the outlet passage which connects to be a continuation of the first part in the plunger stem, and typically is radially-directed. The head usually also comprises the discharge nozzle.

The plunger head may have a discrete trim component, such as a surrounding shroud or outer cover which fits over the plunger head e.g. to give it a selected colour or finish.

The pump body may comprise a cylinder portion and an insert portion fitting into a top of the cylinder portion.

The insert portion may define a guide opening through which the plunger stem moves. As mentioned, it may comprise the bottom spring abutment e.g. as an upwardly-directed surface of an inward projection e.g. defining the guide opening. The insert portion may comprise an upstanding spring surround as mentioned, projecting up towards the plunger head. In general form, the insert portion preferably has a locating projection such as a radial flange portion which lies on a top rim of the cylinder to locate the two parts axially, and a plug portion which fits down inside the cylinder at an upper region thereof.

A particular issue of a pre-compression mechanism of the kind described is that the pre-compression spring—which is above the piston, outside the pump chamber—occupies a lower part of the plunger stem which might otherwise be a location for positioning the main pump spring outside the pump chamber. The present proposal for positioning a pump spring acting between the pump body and plunger head (such as through a spring-retaining adapter) enable the two functions to be combined in the same pump.

A second aspect here is a method or procedure in which

(1) a pump body and pump plunger (but not the plunger head) of a dispenser pump according to any proposal herein are assembled together, and the pump spring positioned on the plunger stem;

(2) the pump spring is retained in position by engagement with a spring-retaining formation at the top of the plunger stem, and most preferably by positioning a discrete spring-retaining adapter on the top end of the plunger stem.

The resulting assembly can be shipped, handled or transferred because the spring is held in place, and desirably also surrounded, where the corresponding surround features are provided. Separately, e.g. at a different facility, choices can be made as for the type of plunger head e.g. the trim or finish of a corresponding plunger head (which may be stored with a range of different trims, finishes or types) and the corresponding type is selected. Then

(3) the head is fixed onto the plunger stem, such as onto the mentioned adapter piece.

At this time a corresponding selection may also been made for a closure element, such as a decorative crimped closure, which may be selected to match the selected plunger head and

(4) fitted to connect the pump to a container to form a pump dispenser.

A third aspect of the invention is a dispenser pump comprising a body and a plunger;

the body comprising a cylinder portion and an insert portion fitting into a top of the cylinder portion, the cylinder portion defining a pump chamber having an inlet with an inlet valve, the pump chamber communicating with an outlet passage and the plunger being reciprocable relative to the body between an extended position and a depressed position in a dispensing stroke to drive liquid from the pump chamber through the outlet passage to a discharge nozzle thereof;

the plunger comprising an actuating head and a stem portion, the insert portion of the body defining a guide opening through which the plunger stem passes, and

a return spring acting between the body and the plunger to bias the plunger up away from the depressed position and towards the extended position,

the return spring having a top extremity retained above an abutment of the cylinder portion, preferably at or adjacent the top thereof, and a lower extremity retained below an abutment of the plunger stem whereby depression of the plunger stretches the return spring.

The top extremity of the return spring may be retained in a trapping recess defined between said abutment which is an upward abutment adjacent a top mouth of the cylinder portion, and a downwardly-directed portion such as plug portion of the discrete insert portion.

By operating the return spring as a tension spring its necessary axial length can be reduced enabling it to be fully enclosed within the body in a compact form.

Preferably the pump comprises a pre-compression mechanism wherein the plunger stem carries a sliding seal member which moves with a piston portion engaging a cylinder wall of the cylinder portion, and which either covers or uncovers one or more entry openings in the stem to communicate between the pump chamber and the outlet passage which is in the stem. The stem carries top and bottom abutments limiting the travel of the seal member, and a pre-compression spring—usually a short coil spring fitted around the plunger stem—acts up against a downward abutment of the stem and down against the seal member.

We particularly prefer that the return spring and the pre-compression spring are comprised as respective upper and lower parts of a single pump spring, the plunger stem having one or more formations constituting an intermediate spring retainer which engages the pump spring between the upper and lower parts thereof. Desirably the intermediate spring retainer formation comprises or consists of a downward shoulder on or around the stem which may be the above-mentioned abutment of the plunger stem whereby when the plunger is depressed, the upper part of the pump spring is stretched while the lower part tends to be compressed for pre-compression.

This combination of the two functions in a single pump spring provides further economy of components and space improving the enclosure of the spring component—which is usually metal—without product contact and enabling the head of the plunger to be exchanged or post-fitted as desired.

In the third aspect as in the first, preferably the pump dispenser is a spray dispenser, the discharge nozzle being an atomiser nozzle.

The head and stem of the plunger are typically discrete components which connect together at respective joint formations thereof. Typically the head has a socket and the top of the plunger stem has a plug formation to fit it, e.g. by a snap fitting.

The plunger head may define a second part of the outlet passage which connects to be a continuation of the first part in the plunger stem, and typically is radially-directed. The head usually also comprises the discharge nozzle.

The plunger head may have a discrete trim component, such as a surrounding shroud or outer cover which fits over the plunger head e.g. to give it a selected colour or finish.

In general form, the insert portion of the body preferably has a locating projection such as a radial flange portion which lies on a top rim at the mouth of the cylinder portion to locate the two parts axially, and a plug portion which fits down inside the cylinder at an upper region thereof.

The following features apply to both or either of the first and third aspects above. The pump body is desirably mounted to a container of liquid to be dispensed by means of a closure structure, especially to mount the pump in the neck of the container. It is possible in principle for a closure structure to be formed integrally with the pump body, but in practice it desirably comprises one or more discrete closure elements, such as an element in the form of a cap which closes off the gap between the pump body and container neck while orienting the pump body coaxially with the neck, fixing its axial position and sealing the join. It may be e.g. a threaded or snap-fitting cap portion. In a preferred embodiment it constitutes or comprises a closure trim or finish component, discrete from the pump body, and which may be selected from a range of options e.g. to match a plunger head trim as mentioned above, such as to match it in colour or finish. Such a closure trim may be in the form of a coat or cover, most especially a crimped cover. Crimped covers are both functional and decorative and well known for use with spray dispensers for example, and are formed during assembly of the pump onto the container by a crimping operation which shapes the closure—typically sheet aluminium—to make interlock formations which lock the relative positions of the pump body and container neck.

Where the pump dispenser is a spray dispenser, it may incorporate a pre-compression mechanism which admits flow in the outlet passage only when a threshold positive pressure between the pump chamber and the outlet passage is exceeded. Such mechanisms are known. We prefer a mechanism where the plunger stem carries a sliding seal member which moves with a piston portion engaging the body's cylinder wall, and either covers or uncovers one or more entry openings to communicate between the pump chamber and the outlet passage which is in the stem. Usually the stem carries top and bottom abutments limiting the travel of the seal member over a movement range (between the covered and uncovered positions relative to the step). A pre-compression spring—usually a short coil spring fitted around the plunger stem—acts up against a downward abutment of the stem and down against the seal member. On depression of the plunger, the top stop of the stem tends to move downwards into engagement with the sliding seal member, which tends to be held in position by frictional outward engagement of the piston against the cylinder wall. This would slide the seal member up the stem, opening entry to the outlet passage. However the pre-compression spring biases the seal member down towards its closed position and this bias is sufficient to overcome the sliding friction of the piston seal against the cylinder wall so that as the plunger is initially depressed, the sliding seal moves down with it and continues to block entry to the outlet passage. Eventually the increasing pressure in the pump chamber is sufficient to drive the piston/seal member back against the spring and open flow to the outlet passage. This ensures an initial flow fast enough for atomisation.

A dispenser comprising any presently-disclosed pump connected to a container of liquid is a further aspect of the invention, as is the part-assembly or precursor mentioned above.

This description uses orientational terms such as “top”, “bottom”, “upper”, “lower” and corresponding expressions such as “outward”, “depress” etc. for ease of description, but these are relative not intended to imply any necessary absolute orientation of the pump. In practice, of course, most pump dispensers are designed to stand with the plunger at the top.

### DESCRIPTION OF THE DRAWINGS

Embodiments of our proposals are now described by way of example, with reference to the accompanying drawings in which:

FIG. 1 is a perspective view of a pump for a fine mist sprayer;

FIG. 2 is a side view of the pump;

FIG. 3 is an axial cross-section at III-III of FIG. 2;

FIG. 4 is an axial cross-section, perpendicular to FIG. 3;

FIG. 5 is an axial cross-section corresponding to FIG. 4, showing a part-assembly or pump module precursor of the embodiment;

FIG. 6 is an axial cross-section, corresponding to FIG. 4, of a second embodiment of our proposals, and

FIG. 7 is an axial cross-section of a third embodiment.

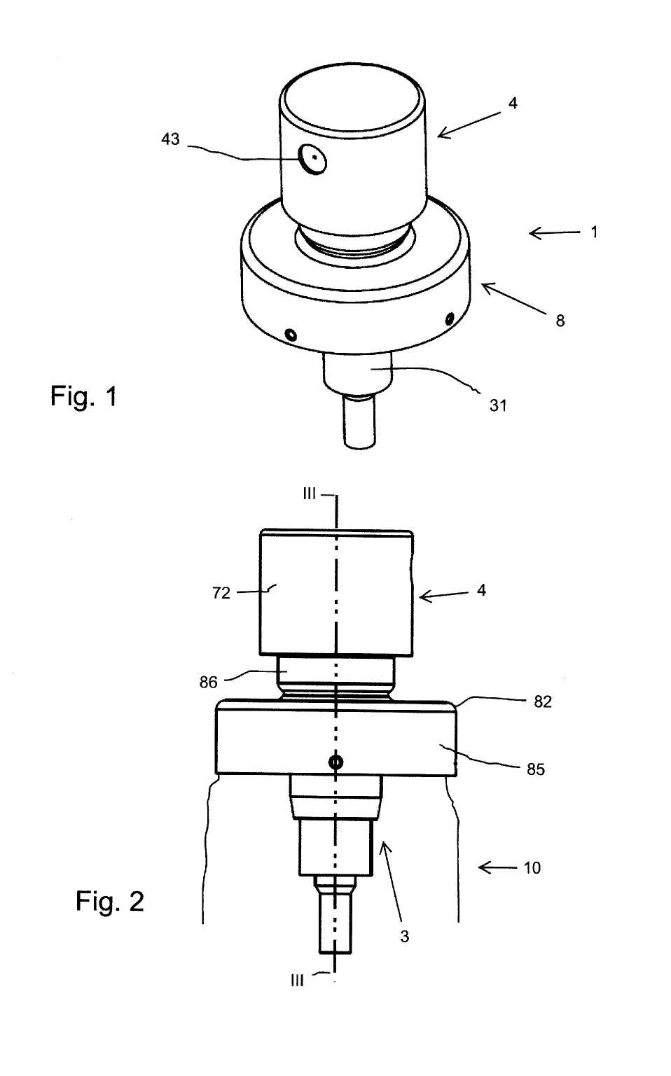

### DETAILED DESCRIPTION

The illustrated embodiment of dispenser pump is a fine mist sprayer 1. The pump consists generally of a body 3, a plunger 2 reciprocable in the body 3 and having a head 4 and a stem 5, and a closure 8 which mounts the pump 1 and orients it coaxially in the neck path of a container. The corresponding dispenser also comprises a container 10 for liquid to be sprayed, as indicated schematically in FIG. 2. The container may be conventional.

The body 3 consists of a cylinder 31 and an insert 32. Each of these components, as is conventional, is a one-piece molding in polypropylene. The cylinder 31 has a cylinder wall 310, an inlet 312 at its bottom end with a dip tube holder 315, and at its top end or mouth an enlarged ring or collar 314. The inlet 312 includes an inlet valve which may be of any suitable type, here a nylon ball 33 seated in a valve seat 313.

The insert 32 is a generally tubular piece with a lower plug portion 34 that snaps tightly down inside the mouth of the cylinder 31, a support flange 321 projecting out to lie on top of the cylinder's top ring 314 to locate the components, and an upstanding spring surround 35, in the form of a cylindrical tube, projecting up coaxially above the rest of the pump body. Just below the flange 321 the insert 32 has an inward flange 328 surrounding a central opening through which the plunger stem 5 passes. The top of this flange constitutes a bottom pump spring abutment 36 and the bottom of the flange provides a top plunger stop abutment 324. The lower part of the insert 32 surrounds a cavity 322 which contains a pre-compression spring 75. The bottom edge of the insert forms a seal annulus 329 which, in the plunger's extended position as shown, forms a plug seal into the top of a plunger piston 62 to isolate the cavity 322. The closure 8 is a crimp closure consisting of an aluminium crimp sleeve 82 and a support/seal washer 81 which surrounds the pump body cylinder 31 and rests sealingly on the top edge of the container. The crimp sleeve 82 has a decorative outer surface, with a coloured and/or metallic finish. In a manner generally well known to the skilled person the crimped sleeve 82 is crimped onto the assembly of the container, pump body and washer 81 so that its peripheral holding collar 85 grips the outside of the container neck, a flat top portion 83 overlies the support washer 81, a crimped grip formation 86 surrounds the enlarged top portions of the pump body to hold them in place, and a flat top portion overlies the top flange 321 of the body insert 32, with the upstanding surround 35 of the insert 32 projecting up through a central opening 84 therein.

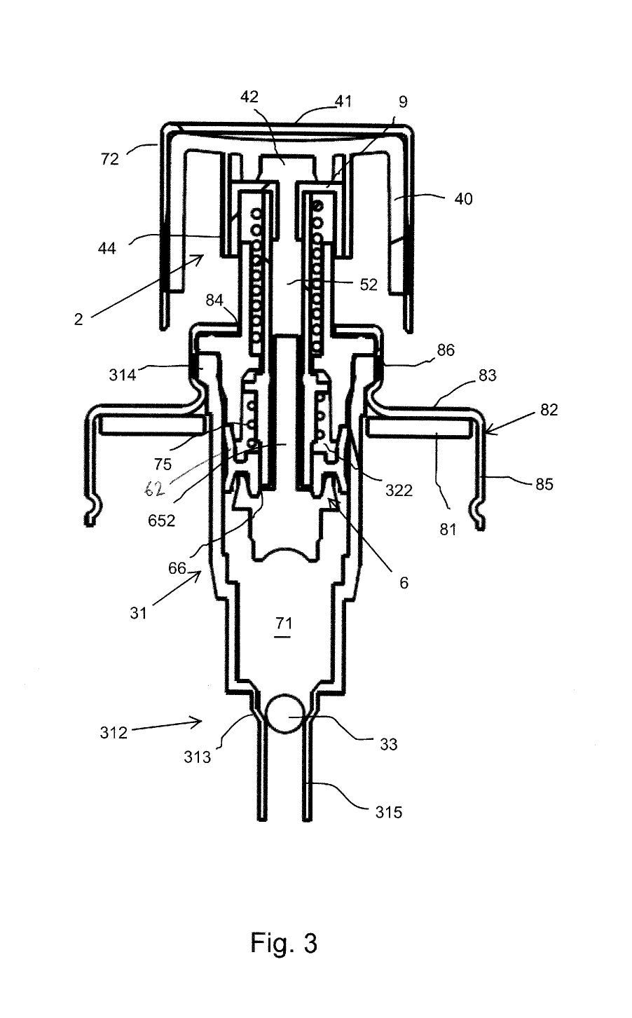

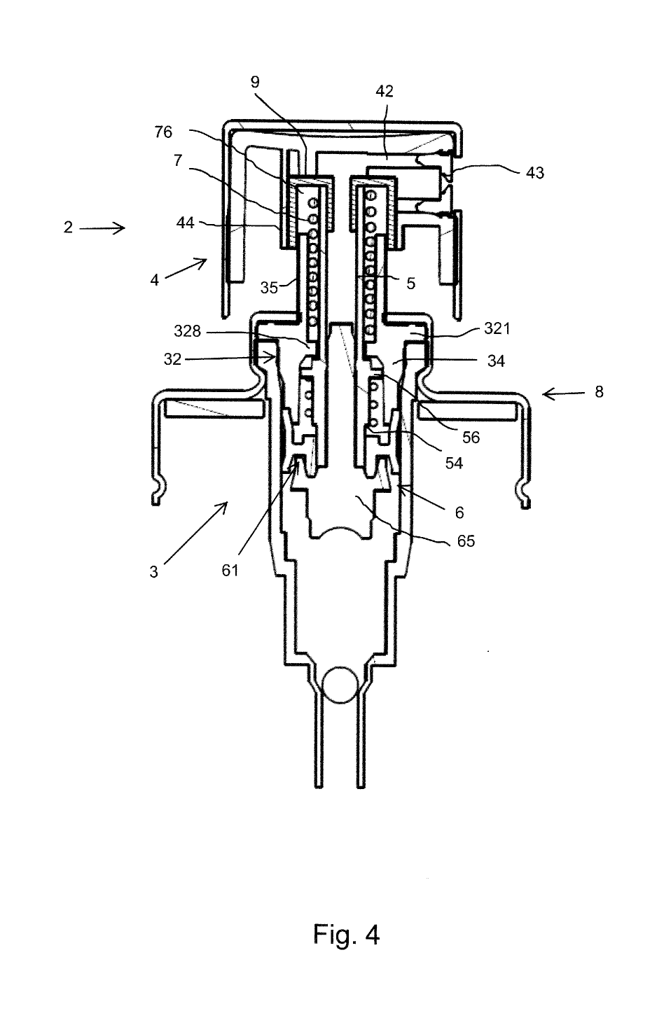

The stem 5 of the plunger is a generally tubular element defining a first outlet passage portion 52. An end piece 65 closes off this passage at the lower end, a rod 652 of the end piece fitting closely up inside the tubular stem. Channels along the rod provide flow clearances up inside the stem for the outlet passage, as seen in FIG. 3. Corresponding entry openings 66 between the bottom end of the stem and the end piece 65 enable communication between the pump chamber 71 and the first portion of the outlet passage 52.

A piston/outlet valve assembly 6 comprises a sliding seal member 61 consisting of a sealing sleeve 63 around the bottom of the stem 5 and a piston seal 62 carried on the sleeve 63 and bearing sealingly against the cylinder wall 310. The sealing sleeve 63 can slide relative to the plunger stem between a lower stop 651 on the end piece 65 and an upper stop 54 provided by a downward shoulder on the stem 5. Further up, the stem 5 provides an upper stop 56, in the form of a circular flange, for the top of the pre-compression spring 75. The bottom of the pre-compression spring 75 acts against the top of the sealing sleeve 63, pressing it down towards the lower stop 651. Immediately above the pre-compression spring stop, the piston stem 5 reduces to a smooth uniform cylindrical outer diameter, and in this form projects up through the central hole defined by the flange 328.

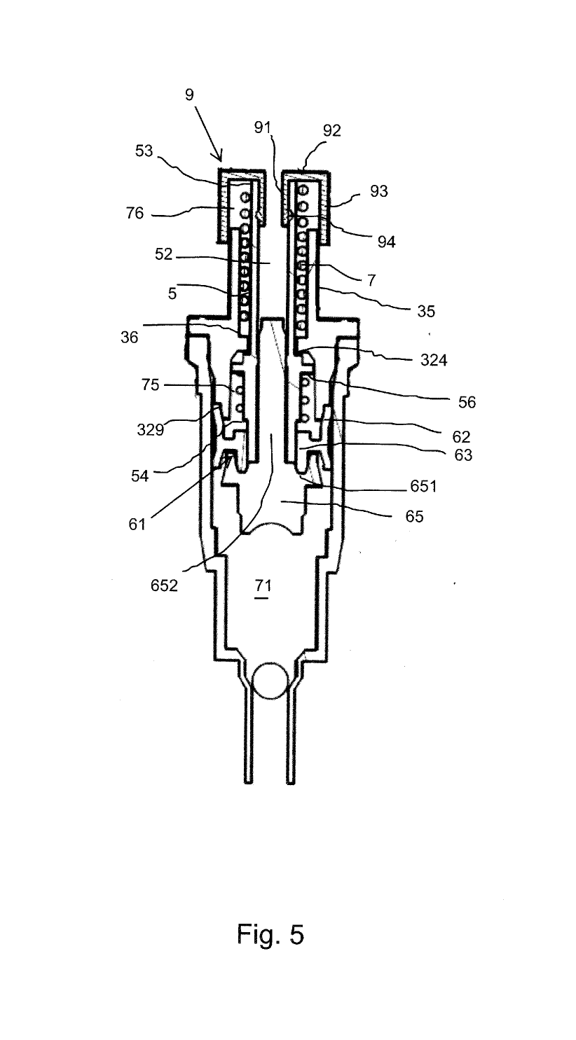

The upwardly-projecting stem 40 5 finishes at a top end 53 with a plain circular opening of the outlet passage 52. Into this opening a spring retainer or spring-retaining adapter 9 is fixed. With reference in particular to FIG. 5, the spring retainer 9 takes generally the form of a deep, inverted U-channel with an inner tube 91 that plugs down inside the stem, engaging by a snap formation 94, a top wall or radial flange 92 projecting out from the top 53 of the step, and an outer tube or depending surround 93. The depending surround 93 is cylindrical in form and extends down so as just to overlap axially—in the extended position shown—the top edge of the upstanding surround 35 of the pump body. They fit telescopically with the upstanding surround on the inside. The upstanding and depending surrounds 35,93 enclose and define, in concert with the top spring retainer wall 92 and the central piston stem 5, an enclosed pump spring chamber 76 in which a pump spring 7 is enclosed. The bottom of the pump spring 7 acts against the top of the inner body flange 328, and the top of the pump spring 7 acts against the underside of the top wall or radial flange 92 of the spring retainer 9.

The inner tube 91 of the retainer 9 defines a part of the outlet passage.

The plunger head 4 comprises a main head piece 40 or button with a top push surface 41, a peripheral cylindrical skirt defining the outer form of the head and a downwardly-directed central socket 44 shaped to fit closely and fixedly—by a snap engagement not indicated—down over the spring-retaining adapter 9 at the top of the plunger stem 5. Specifically, the socket includes an inward cylindrical surface which fits down around the outward cylindrical surface of the outer tube or depending surround 93 of the spring-retaining adapter 9.

The plunger head piece 40 defines a second outlet passage portion 42 which extends as a continuation of the first outlet passage portion 52 in the stem and leads to a radially-directed atomiser nozzle 43 which is the discharge nozzle for the pump. The atomiser nozzle 43 may be conventional. An external trim 72 or outer cover for the plunger head fits closely over the head piece 40 (with a hole at the nozzle 43) and, like the closure crimp sleeve 82 provides a decorative finish to the plunger head 4. This is well-known. In particular, these trim components may be of aluminium which is readily provided with a variety of attractive finishes such as anodised colour finishes. The printing of logos and names is also convenient.

The operation of the pump as a pump is generally conventional and readily understood. The figures show the plunger 2 in the extended position. When the plunger head 4 is depressed, the plunger stem moves down and progressively compresses the pump spring 7. The sliding seal member 61 experiences friction at the piston seal 62 tending to move it up on the stem, but the force of the pre-compression spring 75 overcomes this and keeps it at the bottom of its travel against the lower stop 651 on the end piece 65, keeping the openings 66 shut. The pump chamber 71 contains liquid from a previous priming or dispensing stroke, so the inlet valve is held shut and pressure rises in the pump chamber. After an initial downward (pre-compression) movement, the rising counter-pressure of the liquid overcomes the pre-compression spring 75, and the sealing sleeve 63 moves up along the stem 5 to the upper stop 54, opening the entry openings 66 for rapid flow of the pressurized liquid from the pump chamber 71 along the outlet passage 52,42 and out through the spray nozzle 43.

As the plunger head 4 descends the dependent spring surround 93 slides telescopically down around the upstanding surround 35, continuing to enclose the pump spring 7, until the plunger end point is reached.

When the plunger is released the plunger stem and piston rise, refilling the pump chamber through the inlet valve. The pump spring 7 re-expands, but at even the extended position remains fully enclosed by the tubular surrounds 35,93.

The container interior is vented through the pump in the conventional way, viz. a small hole (not shown) through the cylinder wall at the level of the piston in the extended position.

FIG. 5 shows a pre-assembly or pump module precursor consisting of the pump body, the plunger stem and piston/outlet valve assembly 6, and the pump spring 7 fitted into position and held by the spring retainer 9 so that the spring is securely retained and also fully enclosed to protect it from fouling. This headless pump pre-assembly is universal or standard in that it lacks the visually-distinctive outer components of the closure and plunger. All other functional components are present.

In use, at a facility where the dispensers are filled and assembled, closures and plunger head finishes of the desired type are selected and matched. The assembly of the pumps is completed by application of the closures 8 and by fitting the heads. The heads are fitted by pushing them down onto the spring retainers 9 which act as fitting adapters for this purpose, fitting the head sockets 44. In this procedure the spring need be neither exposed nor released.

Where there is no need to accommodate a variable finish of the closure, such as where the closure is a plastics cap connected to or integral with the pump body, the retaining end enclosure of the spring and the possible variation of the plunger head, are still useful features.

Plunger heads may alternatively be selected for different function or type rather than on decorative grounds.

The upstanding spring surround may be formed as part of a closure rather than part of the pump body.

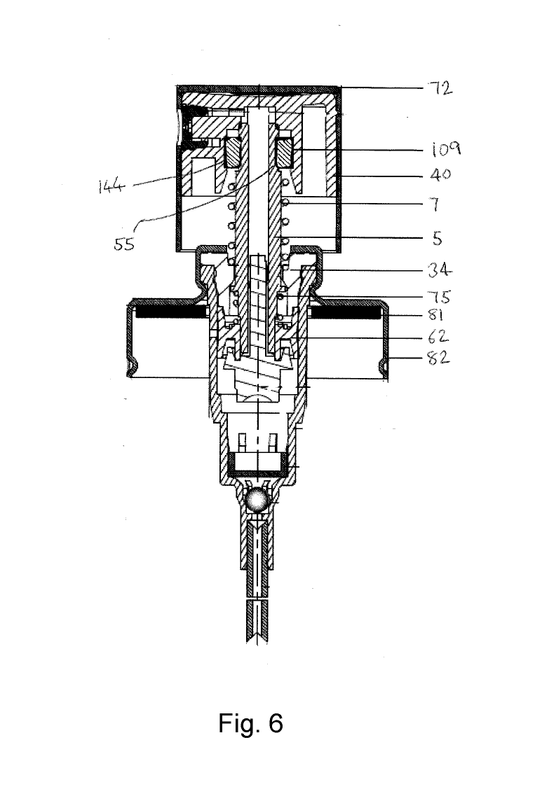

FIG. 6 shows a second embodiment. Reference numerals generally refer to the same components as in the first embodiment, or to similar or analogous components. The second embodiment differs from the first embodiment in the manner retention and accommodation of the spring 7. Instead of the spring-retaining adapter 9 which snaps down inside the top of the plunger stem 5, this embodiment has a thick external retaining ring 109 which snaps down around the top of the plunger stem 5 after the spring 7 is positioned thereon, seating fixedly in an annular groove 55 around the top of the stem, so that it can hold the spring 7 in position in the situation of a pump module precursor as shown in FIG. 5 for the first embodiment. The ring 109 shown has a generally rectangular cross-section with rounded edges for sliding to the snap fit. It may be made of engineering thermoplastics such as acetal polymer (Delrin®). The downward socket of the plunger head 4 is formed with a corresponding inwardly-directed annular groove 144 into which the retaining ring 109 snaps when the head is pushed on, as shown in the figure. The use of this harder polymer ring can hold the head on more securely. In this embodiment the spring 7 is not housed or enclosed by any extension of the pump body. Adequate protection is provided by the downward extent of the side skirt of the decorative trim 72 on the head.

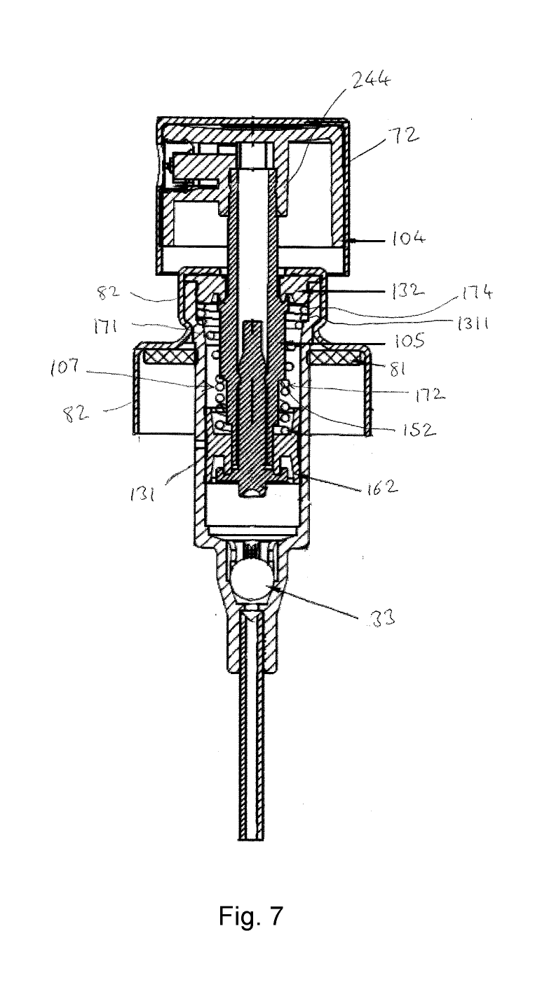

FIG. 7 shows a third embodiment with a substantially different structure. Here the socket 244 of the plunger head 104 snaps directly onto the top of the plunger stem 105 in the conventional fashion, without an intervening adapter or ring. The pump spring 107 is mounted entirely inside the body cylinder 131, and held down in the enclosed cavity beneath the discrete insert or plug portion 132 (which as before is itself enclosed by the top of the external decorative aluminium closure crimp 82).

The pump spring 107 provides restoring force for the plunger 104,105 and pre-compression force for the sliding piston or seal member 162 using two portions of the same metal coil spring. The spring 107 has a lower part or pre-compression part 172 of smaller diameter and an upper part or plunger-return part 171 of larger diameter—in this embodiment of gradually diverging diameter. The top annulus of the spring is trapped between the underside of the insert plug 132 and an upward ledge just beneath the mouth of the cylinder 131, these forming a trapping recess 1311 fixing the top of the spring axially. The top coils of the lower, smaller-diameter part 172 are trapped below a downward shoulder 152 defined around the stem, which constitutes an intermediate spring retainer. The bottom end of the lower, smaller-diameter part 172 acts downwardly against the sliding seal 162.

A distinctive feature here is that the upper spring part 171 is stretched against its resilience by depressing the plunger, because its lower extremity is trapped beneath the intermediate spring retainer 152, and so acts in tension as a return spring to bias the plunger to the extended position. Conversely the lower spring part 172 acts in compression as the pre-compression spring in the conventional manner. By this economy of space and means a single pump spring for a pre-compression spray pump can be entirely housed within the pump body cylinder portion, and thereby be free from obstruction and contamination while also being outside the liquid product path so that there is no metal contact with the liquid product.

1. Dispenser pump comprising:
a body having a cylinder portion and an insert portion fitting into a top of the cylinder portion, the cylinder portion defining a pump chamber having an inlet with an inlet valve, the pump chamber communicating with an outlet passage and the plunger being reciprocable relative to the body between an extended position and a depressed position in a dispensing stroke to drive liquid from the pump chamber through the outlet passage to a discharge nozzle thereof;
a plunger having an actuating head and a stem portion, the insert portion of the body defining a guide opening through which the stem portion passes; and
a return spring acting between the body and the plunger to bias the plunger up away from the depressed position and towards the extended position; and
wherein the return spring includes a top extremity retained above an abutment of the cylinder portion, and a lower extremity retained below an abutment of the stem portion, whereby depression of the plunger stretches the return spring.

2. Dispenser pump of claim 1 wherein a top extremity of the return spring is retained in a trapping recess defined between said abutment of the cylinder portion which is an upward abutment adjacent a top mouth of the cylinder portion, and a downwardly-directed portion of the insert portion.

3. Dispenser pump of claim 1 further comprising a sliding seal member carried on the stem portion, the sliding seal member having a piston portion engaging a cylinder wall of the cylinder portion, and the sliding seal member being movable on the stem portion to either cover or uncover one or more entry openings in the stem portion which communicate between the pump chamber and the outlet passage in the stem portion.

4. Dispenser pump of claim 3 wherein the stem portion has top and bottom abutments limiting said movement of the sliding seal member, and the pump chamber comprises a pre-compression spring which acts upwardly against a downward abutment of the stem and downwardly against the sliding seal member.

5. Dispenser pump of claim 4 wherein the return spring and the pre-compression spring are provided respectively as upper and lower parts of a pump spring, the stem portion having one or more formations constituting an intermediate spring retainer which engages the pump spring between the upper and lower parts thereof.

6. Dispenser pump of claim 5 wherein the intermediate spring retainer formation comprises a downward shoulder proximate to the stem portion whereby, when the plunger is depressed, the upper part of the pump spring is stretched while the lower part tends to be compressed for pre-compression.

7. Dispenser pump of claim 5 wherein the upper part of the pump spring has a larger diameter than the lower part.

8. A dispenser pump comprising:
a body defining a pump chamber having an inlet with an inlet valve, the pump chamber communicating with an outlet passage and the plunger being reciprocable relative to the body between an extended position and a depressed position in a dispensing stroke to drive liquid from the pump chamber through the outlet passage to a discharge nozzle thereof;
a plunger comprising an actuating head and a stem portion;
a return spring acting between the body and the plunger to urge the plunger towards the extended position, the return spring being compressed as the plunger is moved to the depressed position;
wherein the return spring is a coil spring disposed around the plunger stem outside the pump chamber and wherein the body includes a pump spring abutment and an end of the return spring engaging the pump spring abutment.

9. Dispenser pump of claim 8 wherein the plunger comprises a top spring abutment to engage the top of the return spring and the body comprises a bottom spring abutment to engage a bottom of the pump spring.

10. Dispenser pump of claim 9 wherein the plunger comprises a discrete adapter piece fitted to the end of the stem portion and serving as the top spring abutment, and the actuating head of the plunger is held to the stem portion by said adapter piece.

11. Dispenser pump of claim 8 wherein the plunger comprises a dependent spring surround and the body comprises an upstanding spring surround, said dependent and upstanding spring surrounds being movable telescopically together and surrounding the return spring.

12. Dispenser pump of claim 8 wherein the dispenser pump is a spray dispenser and wherein the discharge nozzle is an atomiser nozzle.

13. Dispenser pump of claim 8 wherein the dispenser pump in which the actuating head has a socket and the top of the plunger stem portion fits into the socket.

14. Dispenser pump of claim 8 wherein the dispenser pump in which the actuating head comprises a discrete trim component.

15. Dispenser pump of claim 12 wherein the dispenser pump in which the pump body is mounted in the neck of a container of liquid to be dispensed by means of a closure structure comprising an element in the form of a cap which closes off the gap between the pump body and container neck while orienting the pump body coaxially with the neck, and which comprises a closure trim component.

16. Dispenser pump of claim 15 in which the closure trim component is an aluminium crimp cover.
